(19) United States
(12) Patent Application Publication
(10) Pub. No.: US 2016/0306081 A1
(43) Pub. Date: Oct. 20, 2016

(54) PRISM FILM, METHOD FOR MANUFACTURING THE PRISM FILM, AND LIQUID CRYSTAL DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Hongyan Xing, Beijing (CN); Yanyan Yin, Beijing (CN); Ziwei Cui, Beijing (CN); Jing Xue, Beijing (CN); Hao Wu, Beijing (CN); Yajuan Chen, Beijing (CN)

(73) Assignee: BOE TECHNOLOGY GROUP CO., LTD., Beijing (CN)

(21) Appl. No.: 14/778,057

(22) PCT Filed: Mar. 16, 2015
(86) PCT No.: PCT/CN2015/074271

§ 371 Date: Sep. 17, 2015

(30) Foreign Application Priority Data
Oct. 27, 2014 (CN) 201410584972.X

(51) Int. Cl. G02B 5/04; G02B 1/14; G02B 1/04; G02F 1/1335

(52) U.S. Cl. CPC G02B 5/04; G02F 1/133606; G02B 1/14; G02B 1/04; G02F 2001/133607

(57) ABSTRACT

The present invention relates to the technical field of display, in particular to a prism film, a method for manufacturing the prism film, and a liquid crystal display device. The prism film comprises a prism film substrate and a polarizing layer; an upper surface of the prism film substrate is a prism surface, a lower surface of the prism film substrate is a bonding surface; the polarizing layer is formed on the bonding surface of the prism film substrate. In such a manner, the poor attachment problems of attaching a polarizing sheet on a liquid crystal cell in the manufacturing technology of a liquid crystal panel can be avoided; meanwhile the problem of the polarizing sheet being scratched during assembling the liquid crystal panel in other processes can also be avoided.

### FIELD OF THE INVENTION

The present invention relates to the technical field of display, in particular to a prism film, a method for manufacturing the prism film, and a liquid crystal display device.

### BACKGROUND OF THE INVENTION

At present, liquid crystal display has become the mainstream products of computer monitors and high-end TV displays, while in the field of small size displays, such as mobile phones, PAD (tablet PC), and digital photo frame, liquid crystal display even occupies the dominant position.

An existing liquid crystal display needs a backlight module to provide a light source. FIG. 1 is a cross-section view of a basic optical structure of an existing liquid crystal display. The basic optical structure comprises: a liquid crystal cell 1 (LCD panel), wherein a polarizing sheet 8 is arranged on both sides of the liquid crystal cell 1; a protective film 2; a prism film 3; a diffusion film 4; a light guide plate 5; a reflection film 6; and a lamp tube 7.

However, in the existing manufacturing technology of a liquid crystal panel, during the process of attaching the polarizing sheet on both sides of the liquid crystal cell, poor attachment problems such as bubbles, stains and bonded foreign body are easy to occur for the polarizing sheet; moreover, during other processes, the polarizing sheet is apt to be scratched, resulting in an unqualified liquid crystal display device.

Therefore, for the above problems, the invention provides a prism film, a method for manufacturing the prism film, and a liquid crystal display device.

### SUMMARY OF THE INVENTION

### (1) Problems to be Solved

The object of the present invention is to provide a prism film, a method for manufacturing the prism film, and a liquid crystal display device, thereby solving the problems of poor attachment of attaching a polarizing sheet on a liquid crystal cell in the existing manufacturing technology of a liquid crystal panel and the problem of the polarizing sheet being apt to be scratched.

### (2) Technical Solutions

To this end, an aspect of the present invention provides a prism film used in a liquid crystal display device; the prism film comprises a prism film substrate and a polarizing layer; an upper surface of the prism film substrate is a prism surface, a lower surface of the prism film substrate is a bonding surface; the polarizing layer is formed on the bonding surface of the prism film substrate.

Preferably, the prism film substrate comprises a plurality of base layers comprising prism structure.

Preferably, the material of the base layer is polyethylene terephthalate.

Preferably, the prism film further comprises a protective layer, the protective layer is located on a surface of the polarizing layer opposite to the bonding layer.

Preferably, the material of the polarizing layer is polyving akohol.

Preferably, the material of the protective layer is cellulose triacetate.

Another aspect of the present invention provides a method for manufacturing a prism film, wherein the method comprises:

S1 forming a polarizing layer on a lower surface of a prism film substrate;

S2 forming a protective layer on a lower surface of the polarizing layer.

Another aspect of the present invention provides a liquid crystal display device, wherein the liquid crystal display device comprises a liquid crystal cell and a backlight module matching the liquid crystal cell; the backlight module comprises the above mentioned prism film.

The prism film can be located between the liquid crystal cell and a diffusion film.

The liquid crystal display device can further comprise a panel protective film, the panel protective film is arranged between the prism film and the liquid crystal cell.

### (3) Beneficial Effects

The solutions provided by the present invention have the following beneficial effects: in the prism film, the method for manufacturing the prism film, and the liquid crystal display device provided by the present invention, a polarizing layer is formed on the lower surface of the prism film substrate; under the premise of ensuring the light converging function of the prism film and the function of the polarizing layer for forming polarized light, the poor attachment problems of attaching a polarizing sheet on a liquid crystal cell in the manufacturing technology of a liquid crystal panel can be avoided; meanwhile the problem of the polarizing sheet being scratched during assembling the liquid crystal panel in other processes can also be avoided.

### BRIEF DESCRIPTION OF THE DRAWINGS

FIG. 1 is a schematic diagram of a basic optical structure of an existing liquid crystal display;

FIG. 2 is a structural diagram of a prism film used in a liquid crystal display device according to an embodiment of the present invention.

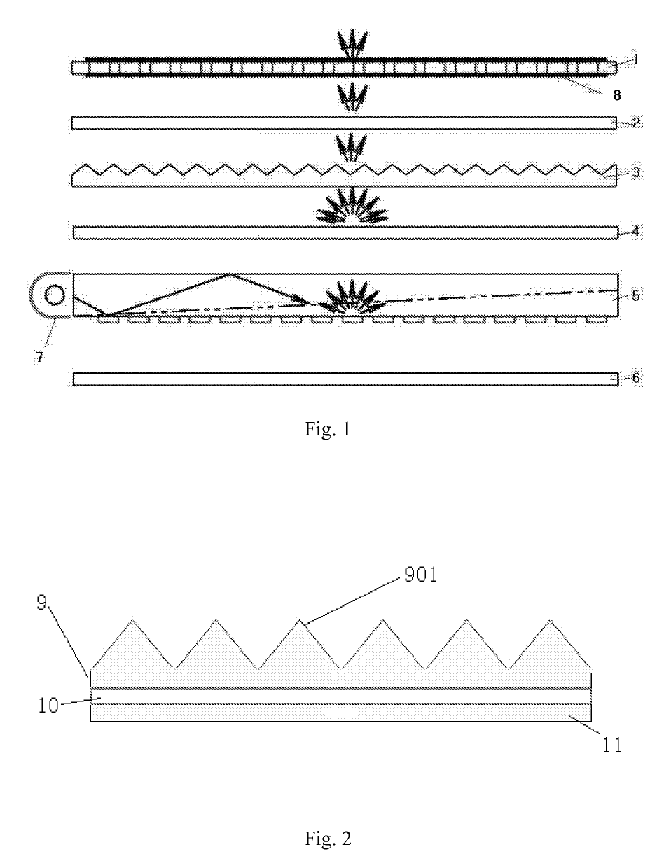

In the drawings: 1—liquid crystal cell; 2—panel protective film; 3—prism film; 4—diffusion film; 5—light guide plate; 6—reflection film; 7—lamp tube; 8—polarizing sheet; 9—prism film substrate; 10—polarizing layer; 11—protective layer; 901—prism surface.

### DETAILED DESCRIPTION OF THE INVENTION

In the following, the technical solutions in embodiments of the invention will be described clearly and completely in connection with the drawings in the embodiments of the invention. Obviously, the described embodiments are only part of the embodiments of the invention, and not all of the embodiments. Based on the embodiments in the invention, all other embodiments obtained by those of ordinary skills in the art under the premise of not paying out creative work pertain to the protection scope of the invention.

In the description of the present invention, it can be understood that the terms such as “upper”, “lower”, “front”, “rear”, “left”, “right”, “top”, “bottom”, “in” and “out” indicate direction or location relationship is based on the direction or location relationship shown in the drawings; they are used only for describing the present invention and simplifying the description, not for indicating or hinting that the device or element should be in the direction, or should be constructed or manipulated in a specific direction; therefore these terms should not be construed as limitations on the present invention.

In the description of the present invention, it should be noted that unless there are express rules and limitations, the terms such as “mount”, “connect” and “bond” should be comprehended in broad sense. For example, it can mean a permanent connection, a detachable connection, or an integrate connection; it can mean a mechanical connection or an electrical connection; it can mean a direct connection, an indirect connection by an intermediate, or an inside connection between two elements. For those skilled in the art, the specific meaning of the above mentioned terms can be construed in specific situations.

As shown in FIG. 2, a prism film used in a liquid crystal display device provided by the present invention comprises a prism film substrate 9 and a polarizing layer 10; an upper surface of the prism film substrate 9 is a prism surface 901, a lower surface of the prism film substrate 9 is a bonding surface; the polarizing layer 10 is formed on the bonding surface of the prism film substrate 9. To protect the polarizing layer 10, the prism film can further comprise a protective layer 11; the protective layer 11 is located on a surface of the polarizing layer 10 opposite to the bonding layer. The protective layer 11 can be coated on the lower surface of the polarizing layer 10.

In a liquid crystal display device, with the above mentioned solutions, instead of the existing method of attaching polarizing sheets on both (i.e., upper and lower) sides of a liquid crystal cell 1, the polarizing layer 10 can be coated on the lower surface of the prism film substrate 9; under the premise of ensuring the light converging function of the prism film and the function of the polarizing layer for forming polarized light, the poor attachment problems of attaching a polarizing sheet on a liquid crystal cell 1 in the manufacturing technology of a liquid crystal panel can be avoided, such as bubbles, stains and bonded foreign body being easy to occur for the polarizing sheet; meanwhile the problem of the polarizing sheet being scratched during assembling the liquid crystal panel in other processes can also be avoided.

Preferably, the prism film substrate comprises a plurality of base layers comprising prism structure; the material of the base layer is polyethylene terephthalate. Since each base layer has a prism structure, there are interspaces between the prisms of adjacent base layers; when the prism film is heated, the amount of expansion mainly fill the interspaces between the prisms; when the interspaces are filled up, an overall expansion of the prism film substrate then occurs, thereby reducing the overall expansion of the heated prism film, solving the problem of uneven prism film when it is heated.

Preferably, the material of the polarizing layer 10 is polyving akohol (PVA); the material of the protective layer is cellulose triacetate (TAC). Certainly, the polarizing layer 10 can also be made of materials with the same function; the protective layer 11 can also be made of other materials with suitable protective function.

Another aspect of the present invention provides a method for manufacturing a prism film, wherein the method comprises:

S1 forming a polarizing layer 10 on a lower surface of a prism film substrate 9; in particular, coating a layer of polyving akohol on a lower surface of a prism film substrate 9 as a polarizing layer 10.

Preferably, the method further comprises:

S2 forming a protective layer 11 on a lower surface of the polarizing layer 10; in particular, coating a layer of cellulose triacetate on a lower surface of the polarizing layer 10 as a protective layer 11.

Furthermore, a liquid crystal display device provided by the present invention comprises a liquid crystal cell and a backlight module matching the liquid crystal cell; the backlight module comprises the above mentioned prism film.

Preferably, the backlight module further comprises a diffusion film; the prism film is located between the liquid crystal cell and the diffusion film.

Preferably, the liquid crystal display device further comprises a panel protective film, the panel protective film is arranged between the prism film and the liquid crystal cell avoiding adverse outcomes of the prism film being in direct contact with the liquid crystal cell.

In a liquid crystal display device applying the prism film according to the embodiments of the present invention, the poor attachment problems of attaching a polarizing sheet and the problem of the polarizing sheet being scratched are avoided, therefore the qualified rate of products is improved greatly. Moreover, if the polarizing layer 10 of the prism film has a defect, the prism film can be replaced directly, reducing routine maintenance for the polarizing sheet.

In conclusion, in the prism film, the method for manufacturing the prism film, and the liquid crystal display device provided by the present invention, a polarizing layer 10 is formed on the lower surface of the prism film substrate 9; under the premise of ensuring the light converging function of the prism film and the function of the polarizing layer for forming polarized light, the poor attachment problems of attaching a polarizing sheet on a liquid crystal cell in the manufacturing technology of a liquid crystal panel can be avoided; meanwhile the problem of the polarizing sheet being scratched during assembling the liquid crystal panel in other processes can also be avoided. By coating a protective layer 11 on the lower surface of the polarizing layer 10 of the prism film, water and air can be isolated, such that it is avoided that the polarizing layer 10 will lose polarizing function since it is apt to absorb water and color fading. If the polarizing layer 10 of the prism film has a defect, the prism film can be replaced directly, reducing routine maintenance for the polarizing sheet.

Apparently, the person skilled in the art may make various alterations and variations to the invention without departing the spirit and scope of the invention. As such, provided that these modifications and variations of the invention pertain to the scope of the claims of the invention and their equivalents, the invention is intended to embrace these alterations and variations.

1. A prism film, wherein the prism film comprises a prism film substrate and a polarizing layer; an upper surface of the prism film substrate is a prism surface, a lower surface of the prism film substrate is a bonding surface; the polarizing layer is formed on the bonding surface of the prism film substrate.

2. The prism film according to claim 1, wherein the prism film substrate comprises a plurality of base layers comprising prism structure.

3. The prism film according to claim 2, wherein the material of the base layer is polyethylene terephthalate.

4. The prism film according to claim 1, wherein the prism film further comprises a protective layer, the protective layer is located on a surface of the polarizing layer opposite to the bonding layer.

5. The prism film according to claim 1, wherein the material of the polarizing layer is polyving akohol.

6. The prism film according to claim 4, wherein the material of the protective layer is cellulose triacetate.

7. A method for manufacturing a prism film, wherein the method comprises:
S1 forming a polarizing layer on a lower surface of a prism film substrate; wherein an upper surface of the prism film substrate is a prism surface.

8. The method for manufacturing a prism film according to claim 7, wherein forming a polarizing layer on a lower surface of a prism film substrate comprises: coating a layer of polyving akohol on a lower surface of a prism film substrate as a polarizing layer.

9. The method for manufacturing a prism film according to claim 7, wherein the method further comprises:
S2 forming a protective layer on a lower surface of the polarizing layer.

10. The method for manufacturing a prism film according to claim 9, wherein forming a protective layer on a lower surface of the polarizing layer comprises: coating a layer of cellulose triacetate on a lower surface of the polarizing layer as a protective layer.

11. A liquid crystal display device, wherein the liquid crystal display device comprises a liquid crystal cell and a backlight module matching the liquid crystal cell; the backlight module comprises the prism film according to claim 1.

12. The liquid crystal display device according to claim 11, wherein the backlight module further comprises a diffusion film; the prism film is located between the liquid crystal cell and the diffusion film.

13. The liquid crystal display device according to claim 12, wherein the liquid crystal display device further comprises a panel protective film, the panel protective film is arranged between the prism film and the liquid crystal cell.

14. The method for manufacturing a prism film according to claim 8, wherein the method further comprises:
S2 forming a protective layer on a lower surface of the polarizing layer.

15. The method for manufacturing a prism film according to claim 14, wherein forming a protective layer on a lower surface of the polarizing layer comprises: coating a layer of cellulose triacetate on a lower surface of the polarizing layer as a protective layer.

16. The liquid crystal display device according to claim 11, wherein the prism film substrate comprises a plurality of base layers comprising prism structure.

17. The liquid crystal display device according to claim 16, wherein the material of the base layer is polyethylene terephthalate.

18. The liquid crystal display device according to claim 11, wherein the prism film further comprises a protective layer, the protective layer is located on a surface of the polarizing layer opposite to the bonding layer.

19. The liquid crystal display device according to claim 11, wherein the material of the polarizing layer is polyving akohol.

20. The liquid crystal display device according to claim 19, wherein the material of the protective layer is cellulose triacetate.
